(19) United States
(12) Patent Application Publication
(10) Pub. No.: US 2024/0346339 A1
(43) Pub. Date: Oct. 17, 2024

(54) GENERATING A QUESTION ANSWERING SYSTEM FOR FLOWCHARTS

(71) Applicant: International Business Machines Corporation, Armonk, NY (US)

(72) Inventors: Joseph Shtok, Binyamina (IL); LEONID KARLINSKY, Acton, MA (US); Simon Magnus Tannert, Stuttgart (DE); Jasmina Bogojeska, Adliswil (CH); Marcelo Gabriel Feighelstein, Zychron Yaakov (IL)

(21) Appl. No.: 18/301,514

(22) Filed: Apr. 17, 2023

(51) Int. Cl. G06N 5/022; G06F 16/901

(52) U.S. Cl. CPC G06N 5/022; G06F 16/9024

(57) ABSTRACT

Aspects of the disclosure include methods, systems, and computer program products for generating semantically meaningful question-answer pairs for graph-like charts, such as flowcharts. In one example, a method of implementing a Question Answering (QA) system may comprise generating a synthetic dataset of graph-like chart images. The generating may comprise rendering a plurality of graph-like chart images from a plurality of associated graph data, generating a plurality of question-answer pairs for each of the graph-like chart images, and calculating a plurality of ground truth annotations for each of the plurality of question-answer pairs and associated graph-like chart images from the plurality of associated graph data. The method of implementing the QA system may further comprise training a vision-language architecture on the synthetic dataset to answer questions about the graph-like chart images.

### STATEMENT REGARDING PRIOR DISCLOSURES BY THE INVENTOR OR A JOINT INVENTOR

The following disclosure is submitted under 35 U.S.C. 102 (b)(1)(A):
Simon Tannert, Marcelo Feighelstein, Jasmina Bogojeska, Joseph Shtok, Assaf Arbelle, Peter Staar, Anika Schumann, Jonas Kuhn, and Leonid Karlinsky, “FlowchartQA: The First Large-Scale Benchmark for Reasoning over Flowcharts,” In Proceedings of DI@KDD'22, ACM, Washington DC, U.S., (Aug. 14-18, 2022), which is herein incorporated by reference in its entirety.

### BACKGROUND

The present disclosure relates to document artificial intelligence (document AI), and more specifically, to analyzing graphical elements of graph-like charts, such as flowcharts, to enable automatic information retrieval by document AI models, such as a question-answer system.

A flowchart is a type of graph-like chart that depict a series of operations that define a process, guideline, workflow, system, algorithm, or solution model to a given problem, etc. Flowcharts typically depict associated operations, decision points, etc. using various geometric shapes (e.g., rectangles) connected by directed edges (e.g., arrows). Those directed edges, in turn, indicate the sequence or flow that the operations should be performed. Some flow charts may also comprise undirected edges that define relations.

Flowcharts and other graph-like charts can be used to intuitively communicate complex processes, guidelines, workflows, systems, and algorithms. Because they are easy to understand by both technical and non-technical people, they are widely used in numerous fields, including science, engineering, finance, and sales.

### SUMMARY

One aspect of the disclosure is a system for generating semantically meaningful question-answer pairs for real-world flowcharts accompanied with XML/XMI data and description text, using the BART text generation model. Another aspect of this disclosure is a multi-modal transformer network for multiple choice question answering using ViT for visual feature extraction and BERT for question processing and answer classification, where visual features can be attended by BERT using cross-attention. Another aspect of this disclosure is a new dataset for flowcharts analysis and QA. Another aspect of this disclosure is a fully unsupervised system for flowchart QA, based on the dataset above.

In one example, a method of implementing a Question Answering (QA) system may comprise generating a synthetic dataset of graph-like chart images. The generating may comprise rendering a plurality of graph-like chart images from a plurality of associated graph data, generating a plurality of question-answer pairs for each of the graph-like chart images, and calculating a plurality of ground truth annotations for each of the plurality of question-answer pairs and associated graph-like chart images from the plurality of associated graph data. The method of implementing the QA system may further comprise training a vision-language architecture on the synthetic dataset to answer questions about the graph-like chart images.

In another example, a computer program product for implementing a Question Answering (QA) system may comprise a computer readable storage medium having program instructions embodied therewith. The program instructions may be executable by a processor to cause the processor to generate a synthetic dataset of flowcharts images. The generating may comprise rendering a plurality of flowcharts images from a plurality of associated graph data, generating a plurality of question-answer pairs for each of the flowchart chart images, and calculating a plurality of ground truth annotations for each of the plurality of question-answer pairs and associated flowcharts images from the plurality of associated graph data. The question-answer pairs for each of the graph-like charts may include topological questions about an associated flowchart, geometric questions about spatial relations in the associated flowchart, and semantic questions about a content of an element in the associated flowchart. The program instructions may be executable by a processor to further cause the processor to train a vision-language architecture on the synthetic dataset to answer questions about the graph-like chart images. The vision-language architecture may comprise a Bidirectional Encoder Representations from Transformers (BERT) model and a Vision Transformer (VIT). The training of the vision-language architecture on the synthetic dataset to answer questions about the graph-like chart images may comprise generating a representation of the graph-like chart images using the VIT.

In another example, a system for providing answers to questions posed about flowcharts, wherein the flowcharts are provided as images, may comprise a synthetic dataset generation module adapted to generate a plurality of synthetic flowchart images and a plurality of questions, possible answers, and correct answer tuples from associated graph data. The system may further comprise a vision-language machine learning model trained on the synthetic dataset to answer questions about input flowcharts.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram that depicts an example environment for the execution of at least some of the computer code involved in performing the disclosed methods, such as a vision-language machine learning architecture.

FIG. 2A illustrates an example ML model of a document AI engine, consistent with some embodiments.

FIG. 2B depicts a ML model training method, consistent with some embodiments.

FIG. 3 is a schematic diagram of a vision-language machine learning architecture embodiment trained in self-supervised fashion to perform QA and data extraction from images of flowcharts, consistent with some embodiments.

FIGS. 4A and 4B depict example synthetic flowcharts, which may be used in the synthetic training dataset, consistent with some embodiments.

FIG. 4C depicts an example list of synthetic questions and answers pairs for the synthetic flowchart in FIG. 4A.

FIG. 4D depicts a list of example question templates that may be used to generate the synthetic questions and answers pairs, consistent with some embodiments.

FIG. 5A depicts a system for training the vision-language machine learning architecture, consistent with some embodiments.

FIG. 5B depicts one embodiment of the language encoder in more detail.

FIG. 6 is a flowchart depicting one method of implementing a Question Answering (QA) system for graph-like charts, consistent with some embodiments.

FIGS. 7A and 7B depict example heat maps used to visualize the cross-attention module activation with respect to an example flowchart, projected by the question text on the image, averaged all across transformer layers and heads.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to document artificial intelligence (AI); more particular aspects relate to analyzing graphical elements of graph-like charts, such as flowcharts, to enable automatic information retrieval by document AI models, such as a question-answer system. While the present disclosure is not necessarily limited to such applications, various aspects of the disclosure may be appreciated through a discussion of various examples using this context.

Flowcharts are a type of graph-like chart that is used in many fields to convey large amounts of useful information and knowledge about, e.g., processes, workflows, causality, etc. Accordingly, one aspect of this disclosure is FlowchartQA—a new and first of its kind, large scale visual question-answering (VQA) benchmark for reasoning over flowcharts and other graph-like charts. The questions and answer pairs supported by FlowchartQA, in turn, may cover different aspects of geometric, topological, and semantic information contained in the flowcharts, and may be carefully balanced to reduce sources of bias.

Some embodiments of this disclosure may generate questions, answers, and multiple choice answer candidates related to different flowchart properties. In this way, some embodiments may enable machine understanding of the rich visual information found in flowcharts, and may allow easy, focused access to a large amount of relevant valuable data for automated knowledge extraction systems.

Some embodiments of this disclosure may automatically generate a large synthetic dataset adapted for efficient training of a document AI model, such as a question answering (QA) machine learning model, to reason based on information embedded in flowcharts. The generated synthetic dataset may comprise images of flowcharts, together with annotations of the underlying data, e.g., bounding boxes and outline polygons of nodes and edges, textual labels, and the adjacency matrix of the depicted flowchart. Some embodiments of this disclosure may also use a visual transformer (ViT) for producing the digital representations of the flowchart images for the synthetic dataset, e.g., for use as baselines for training the document AI model. Additionally or alternatively, the edges in the synthetic dataset may have textual or numeric labels, or may be unlabeled; and the nodes and the edges may have different textual and/or graphical styles.

The synthetic dataset creation process may be fully automatic in some embodiments, which may advantageously allow those embodiments to quickly create large-scale datasets for use in training the document AI model. Additionally or alternatively, the synthetic dataset creation process may be parameterized, such that the creation process can be adapted to different domains. Suitable parameters include, without limitation, a control for a maximum number of nodes and edges in the graph, a control for a maximum degree of each node, and a control for whether edges are directed or undirected.

Some embodiments may render flowcharts from an input, ground-truth document to use in training document AI models. The generated flowcharts may be automatically laid out and rendered using any suitable graph rendering process, such as those in the open source Graphviz package available at https://graphviz.org. Additionally, or alternatively, some embodiments may provide the node and edge annotations (e.g., bounding boxes) from the ground truth document to also use in training. The input, ground-truth document may be loaded into any suitable network analysis software, such as the open source networkx package available at https://networkx.org/, to automatically generate correct answers to questions about the graph's topology.

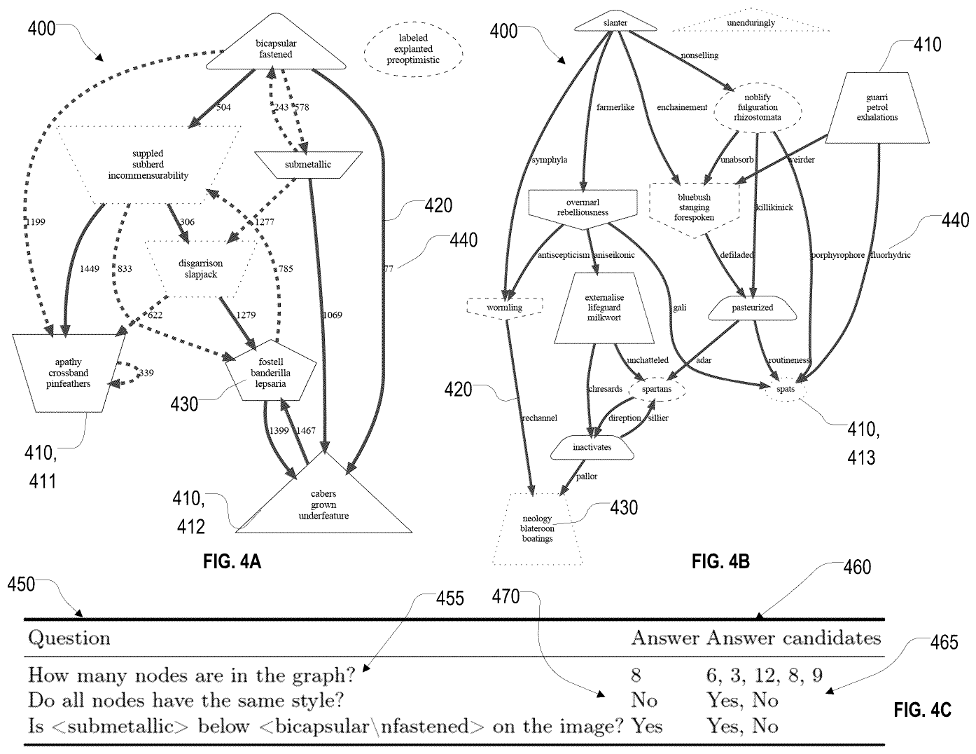

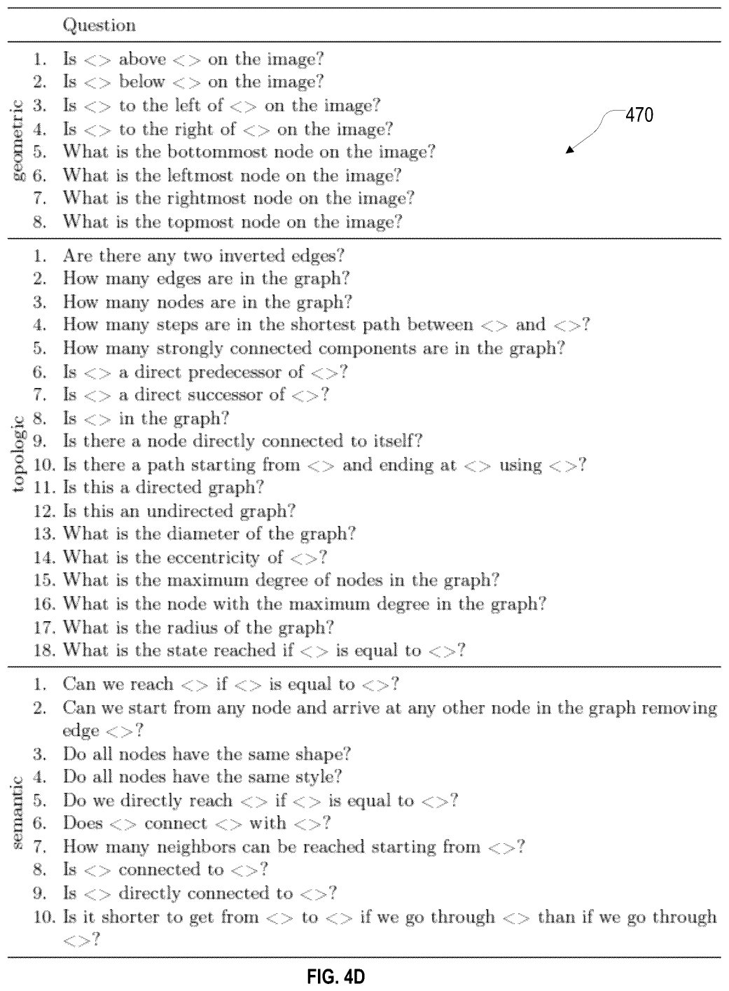

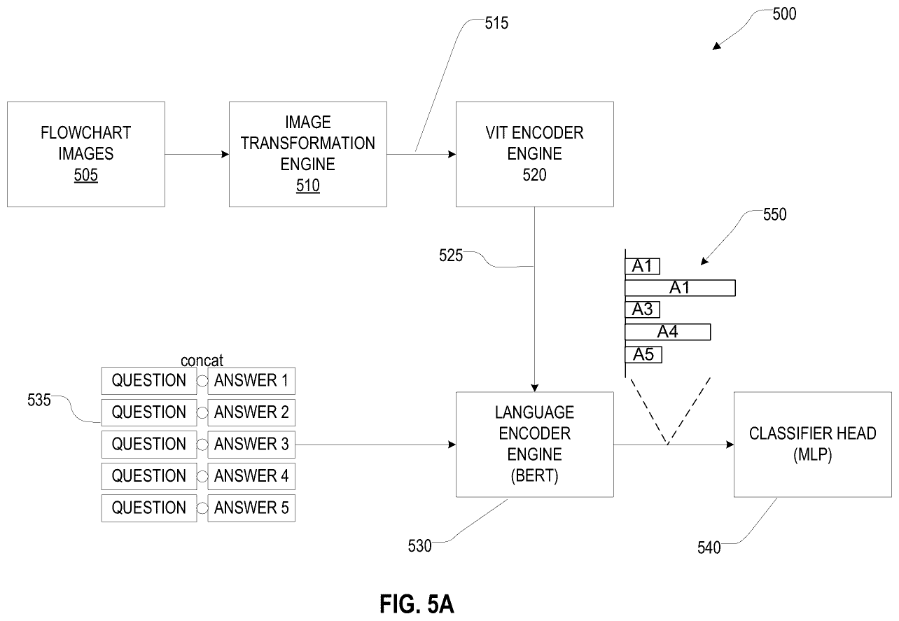

The output of the graph rendering process and the network analysis software may be used during the model training process to generate and evaluate question-answer pairs about the flowchart. For each flowchart, some embodiments may generate question-answer pairs using a plurality (e.g., 100, 200, etc.) of question templates. Some embodiments may categorize the questions into categories, such as geometric, topological, and semantic, based on the knowledge the questions require to answer them. A partial list of example question templates are shown in FIG. 4D.

Some embodiments may provide a system and method for generating semantically meaningful question-answer pairs for real-world flowcharts accompanied with XML/XMI data and description text, using the BART text generation model. One example embodiment may comprise a system for synthetic dataset generation of flowchart images and a vision-language architecture trained on the synthetic/real datasets. The system for synthetic dataset generation, in turn, may be equipped with ground truth labels and annotations for all elements of the flowchart and a balanced set of questions and answers for each flowchart. The vision-language architecture may comprise a combination of a BERT (Bidirectional Encoder Representations from Transformers) model and ViT (Vision Transformers) adapted to receive {flowchart image, question} tuples as input, and to produce a score distribution over answer candidates (multiple choice questions). In some embodiments, the vision-language architecture may further select a most-correct answer from among the answer candidates.

Some embodiments may enable generation of ground truth annotations in the form of node/edge labels, node boxes, and segmentation maps for the edges; and generating sets of questions with multiple choice answers (randomized instances of manually prepared templates) for those ground truth annotations. The questions may be categorized as:
(i) topological (based on the structure of the graph), e.g., “Is it a directed graph?”, “What is the distance between nodes A to B?”, “Can node B be reached from node A?”, etc. and/or
(ii) geometric (based on the image content), e.g., “Is a node A below/above the node B?”, “What is leftmost node of the image?”, etc.
   These embodiments may further allow balancing of the generated questions for improved training efficiency. That is, in random distribution, there may be many questions with a trivial answer, a lot of questions with one prevalent answer, etc. These embodiments may underweight such questions, and consequentially, overweight questions with non-trivial and/or non-prevalent answers. Accordingly, one aspect of this disclosure is a dataset optimized for efficient training, which may accompany the disclosed benchmark.

One feature and advantage of some embodiments is that they may be automatically and rigorously balanced to reduce sources of bias. This feature, in turn, may enable significant deviation-from-chance performance when attempting to answer questions about the respective flowcharts. That is, due to the randomness in the generation process, the resulting dataset can be imbalanced in several ways. Accordingly, some embodiments may sub-sample the question-answer pairs in order to balance the number of instances per distinct answer and the number of instances per question. After balancing the dataset, these embodiments may generate negative answer candidates for multiple-choice question answering. For questions where the answer is a node label, these embodiments may pick up to n−1 node labels from the same graph. For all other questions, these embodiments may sample up to n−1 answers from the answers for the same question in the dataset.

Some embodiments may extend the training process described above, and the resulting document AI model, by: (i) introducing additional tasks (e.g., flowchart components detection and segmentation), (ii) introducing domain specialization by generating chart styles and content specific to certain knowledge domains (e.g., biology, chemistry, computer science, etc.), and (iii) extending the tasks and analysis to few-shot or zero-shot (completely unseen) question types.

Turning now to the Figures, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example environment for the execution of at least some of the computer code involved in performing the inventive methods, such as a vision-language machine learning architecture 300. The vision-language machine learning architecture 300, in turn, may comprise a visual question-answering (VQA) machine learning model. In particular, the VQA system in some embodiments may be adapted to receive a “Question” sentence, e.g., from a human end user via a graphical user interface, and then automatically generate one or more “Answer” sentences to the “Question” sentence. The generated answer(s) may be presented back to the user via the graphical user interface.

The VQA systems in such embodiments are not merely visual search engines. While a visual search engine (e.g., an Internet web search engine) typically has access to an immense source of information and can quickly find relevant results (e.g., pictures) given a small number of query terms, visual search engines do not return answers to specific questions; rather, search engines return a ranked list of results (e.g., pictures) that the user may be trying to find. VQA systems in some embodiments, in contrast, take questions formulated in a standard human language (e.g., English, Spanish, etc.) as input, and then generate an answer to the input question using information extracted from a specific flowchart. The answer may be accompanied with a confidence measure as to how accurate that answer is with respect to the input question. The output of the VQA system may also include summaries of justifying/supporting evidence, which may enable the end user to quickly assess the quality and/or providence of the output answer.

In addition to vision-language machine learning architecture 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

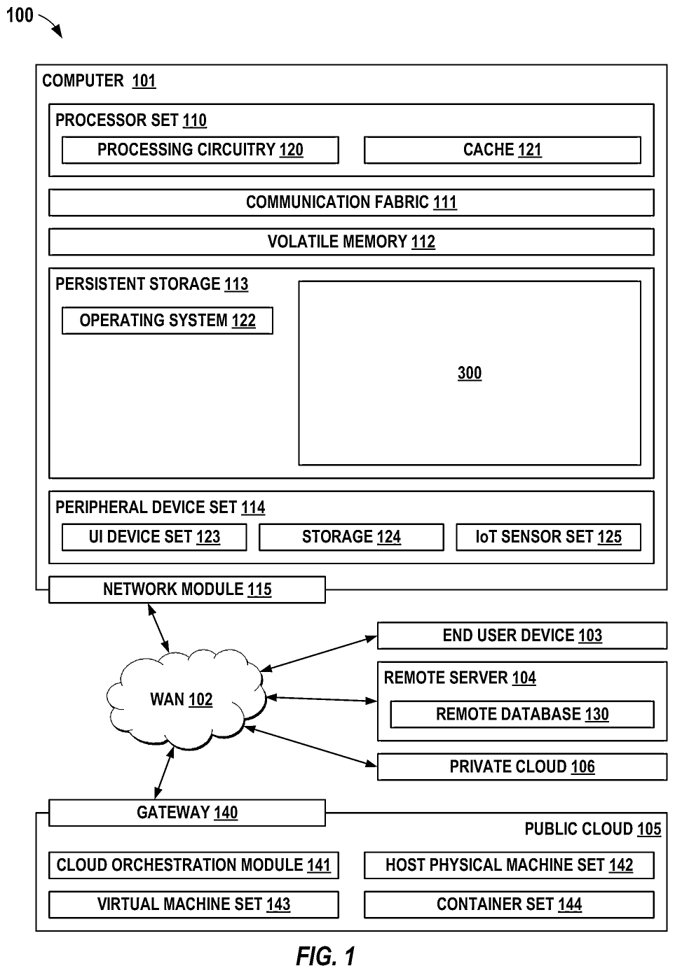

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Document Artificial Intelligence Engine

The document AI engine 300 in some embodiments may comprise one or more machine learning models (ML models). The ML models, in turn, may be any software system that recognizes patterns. In some embodiments, the ML models comprise a plurality of artificial neurons interconnected through connection points called synapses or gates. Each synapse may encode a strength of the connection between the output of one neuron and the input of another. The output of each neuron, in turn, may be determined by the aggregate input received from other neurons that are connected to it, and thus by the outputs of these “upstream” connected neurons and the strength of the connections as determined by the synaptic weights.

The ML models may be trained to solve a specific problem (e.g., QA pair generation based on a particular flowchart, etc.) by adjusting the weights of the synapses such that a particular class of inputs produce a desired output. This weight adjustment procedure in these embodiments is known as “learning.” Ideally, these adjustments lead to a pattern of synaptic weights that, during the learning process, converge toward an optimal solution for the given problem based on some cost function. In some embodiments, the artificial neurons may be organized into layers.

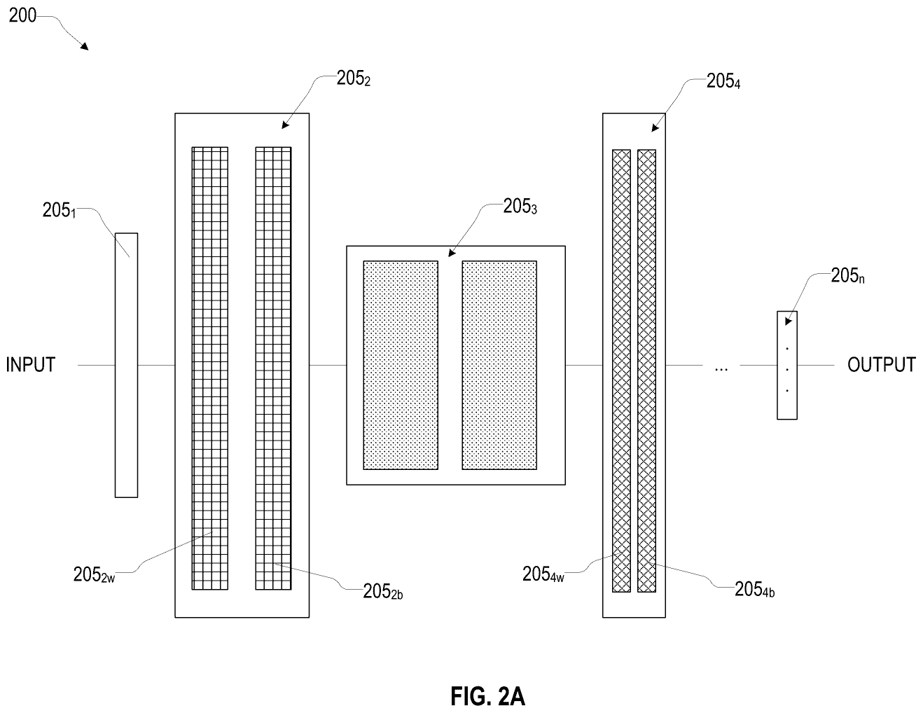

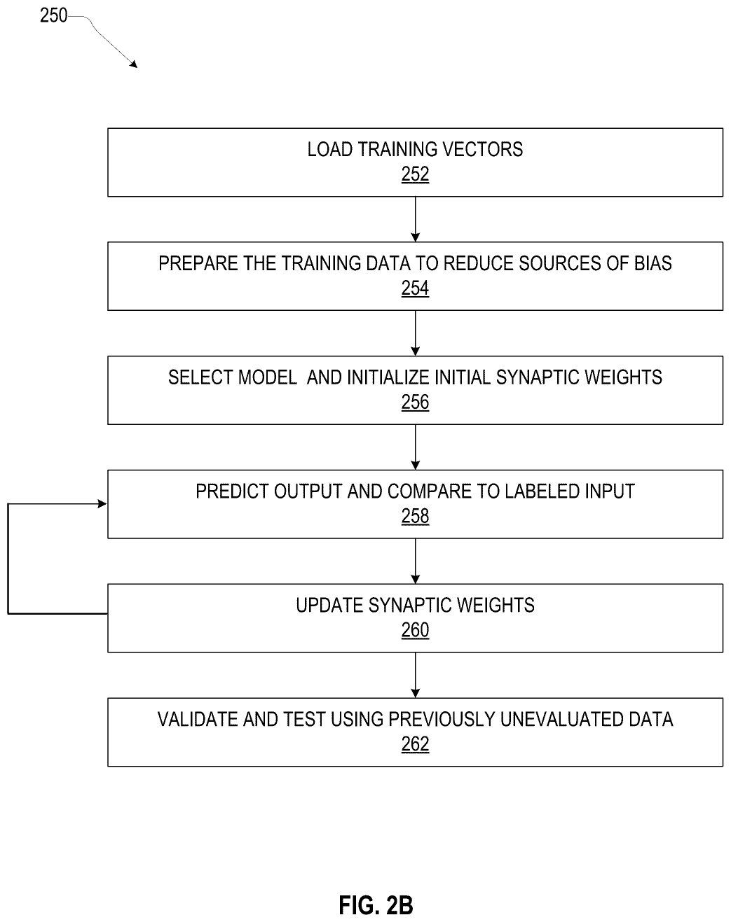

FIG. 2A illustrates an example ML model 200 of a document AI engine 300, consistent with some embodiments. The ML model 200 comprises a plurality of layers 205₁-205ₙ. Each of the layers comprises weights 205_{1w}-205_{nw} and biases 205_{1b}-205_{nb} (only some labeled for clarity). The layer 205₁ that receives external data is the input layer. The layer 205ₙ that produces the ultimate result is the output layer. Some embodiments include a plurality of hidden layers 205₂-205ₙ₋₁ between the input and output layers, and commonly hundreds of such hidden layers. Some of the hidden layers 205₂-205ₙ₋₁ may have different sizes, organizations, and purposes than other hidden layers 205₂-205ₙ₋₁. For example, some of the hidden layers in the ML model may be convolution layers, while other hidden layers may be fully connected layers, deconvolution layers, or recurrent layers.

Referring now to FIG. 2B, a ML model training method 250 is depicted, consistent with some embodiments and described with reference to answer generation as an illustrative example. At operation 252, the system receives and loads training data. In this example, the input data-set may include the synthetic dataset described in more detail below. This synthetic dataset may comprise the output of the graph rendering and/or network analysis processes described in more detail below with respect to a plurality (e.g., hundreds of thousands, millions, etc.) of sample synthetic flowcharts, together with a plurality of sample questions-answer (QA) pairs about each of those questions flowchart, to use during the training process. At operation 254, the training data may be prepared to reduce sources of bias, such as filtering QA pairs with trivial answers, sampling flowcharts from a larger synthetic dataset to match a distribution of nodes and edges characteristics and a distribution of graphical styles in a real-world dataset, etc. This may also include de-duplication, normalization, and order randomization. At operation 256, a model is selected for training and the initial synaptic weights are initialized (e.g., randomized). Depending on the underlying task, suitable models include, but are not limited to, feedforward techniques (e.g., convolutional neural networks), regulatory feedback-based systems, radial basis function (RBF) techniques, and recurrent neural network-based techniques (e.g., long short-term memory). At operation 258, the selected model is used to predict an output using the input data element, and that prediction is compared to the corresponding target data. A gradient (e.g., difference between the predicted value and the target value) is then used at operation 260 to update the synaptic weights. This process repeats, with each iteration updating the weights, until the training data is exhausted, or the model reaches an acceptable level of accuracy and/or precision. At operation 262, the resulting model may optionally be compared to previously unevaluated data to validate and test its performance.

### QA Generation Pipeline

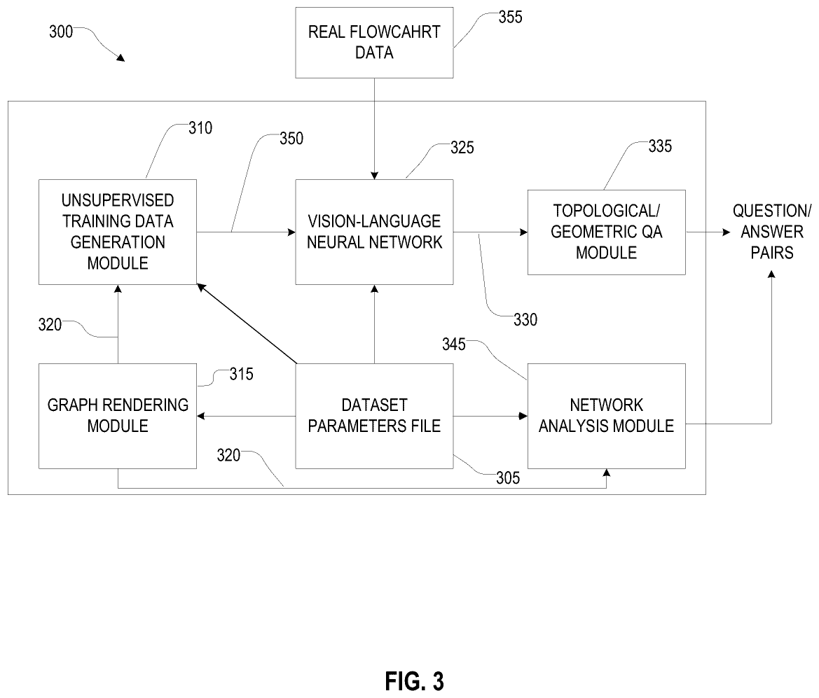

FIG. 3 is a schematic diagram of a vision-language machine learning architecture 300 embodiment trained in self-supervised fashion to perform QA and data extraction from images of flowcharts, consistent with some embodiments. This vision-language machine learning architecture 300 comprises an unsupervised training data generation module 310 adapted to create a synthetic dataset 350. This may include receiving a large number (e.g., hundreds of thousands to millions) of training flowcharts 320 from a graph rendering module 315. The training flowcharts 320 may be created from a dataset parameters file 305.

The synthetic dataset 350 may be used to train a vison-language neural network (VLNN) 325, such as a Bidirectional Encoder Representations from Transformers (BERT) model and a Vision Transformer (ViT), to extract significant features 330 from flowchart images. That is, in this embodiment, the synthetic dataset 350 may be created to look like, and processed as, ground truth data by the VLNN 325 during the training process. In this way, the synthetic dataset 350 may substitute, in whole or in part, for real world flowcharts 355 during the training process. This, in turn, may be desirable because it may be prohibitively expensive to obtain and/or annotate sufficient quantities of the real-world flowchart data 355 to train the VLNN 325.

The significant features 330 from the synthetic dataset 350 may then be used to train a topological/geometric QA module 335, which may generate answers 340 to questions about the training flowcharts 320. Those answers 340 may be compared to answers generated by network analysis module 345 from the dataset parameters file 305. The difference between the answers generated by the VLNN 325 and QA module 335 pipeline, and the answer generated by the network analysis module 345 may be used as a gradient for network training. Optionally, the vision-language machine learning architecture 300 may be subsequently fined tuned on real data 355 from real world (i.e., not synthetic) flowcharts and/or real-world flowcharts augmented with synthetic data. The augmenting may include minimizing change to region(s) of the flowcharts attended by the current vision-language architecture; and maximizing a difference between the flowcharts in the real world flowchart in terms of content and connectivity.

FIGS. 4A and 4B are example synthetic flowcharts 400, which may be used in the synthetic training dataset, consistent with some embodiments. Each synthetic flowchart 400 comprises a plurality of nodes 410 connected by relationships 420 (only some nodes 410 and relationships 420 labeled for clarity). The nodes 410 may comprise a variety of graphical styles and shapes 411, 412, 413, etc., typically indicative of different types of nodes 410. The nodes 410 may also comprise one or more random textual labels 430, typically comprising one or more lines of random human-readable text (e.g., “bicapsular fastened”, “submetallic”, “suppled subherd incommersurability”, etc.), in one or more textual styles and fonts. The relationships 420 may also comprise one or more random labels 440, typically also comprising one or more lines of human readable text. FIG. 4C is an example list 450 of synthetic questions 455 and answers 460 pairs for the synthetic flowchart 400 in FIG. 4A. Each question 455 in the list 450 may also be associated with one or more answer candidates 465. The answer candidates 465 may be associated with a distribution of likely correctness. Each question 455 may also be associated with a best (i.e., most likely correct) answer 470. FIG. 4D is a list 470 of example question templates that may be used to generate the synthetic questions 455 and answers 460 pairs, consistent with some embodiments. The examples in FIG. 4D includes example geometric (e.g., “Is < > above < > on the image?”, etc.), topological (e.g., “Are there any two inverted edges?”, etc.), and semantic question templates (e.g., “Can we reach < > if < > is equal to < >?”, etc.).

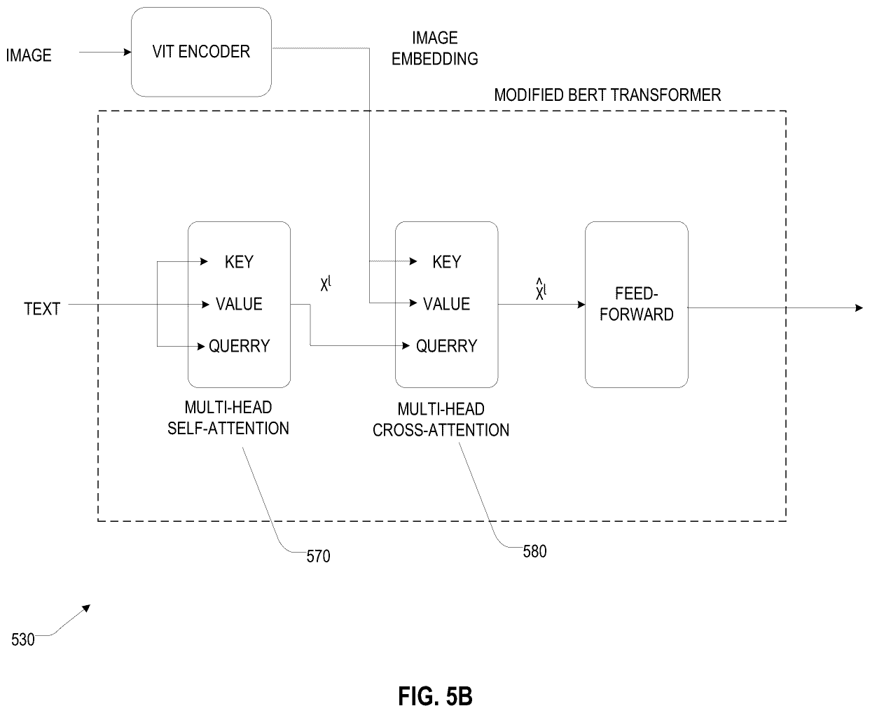

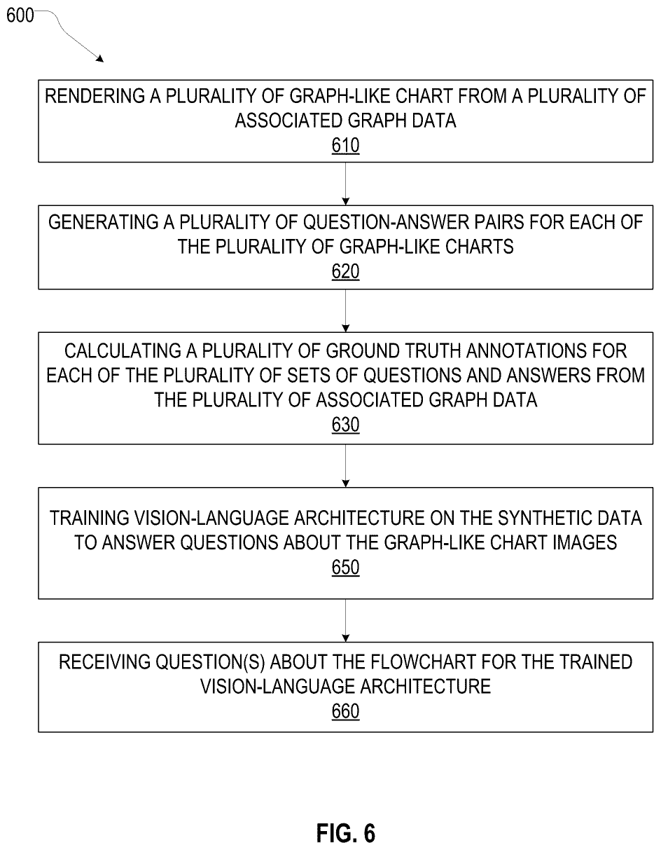

FIG. 5A depicts a system 500 for training the vision-language machine learning architecture 300, consistent with some embodiments. This system 500 comprises an image transformation engine 510, a VIT encoder engine 520, a language encoder engine 530, and a classifier head (MLP) 540. The image transformation engine 510 may receive as input a plurality of input flowchart images 505, such as the synthetic flowcharts described with reference to FIGS. 4A-4C. The image transformation engine 510 may split each image of each input flowchart into a plurality of output tokens 515, such as 16×16 pixels or 24×24 pixels. The VIT encoder engine 520 may analyze the output tokens 515 to generate, for the 16×16 token example, a (196+1)*feature_size image representation 525. The image representation 525 may then be input into the language encoder engine 530. The language encoder 530 may receive as input one or more QA pairs 535 (i.e., questions and answers to those questions) using the embedded image from the VIT encoder engine 520. The classifier head 540 may then compare the distribution/ranking 550 of the output answers (A1-A5) of the language encoder 530 to the base-truth answers generated by, e.g., by the network analysis module 345 (see FIG. 3). The difference between the two sets of answers may then be fed back into the various models to improve their operation, as discussed in more detail with reference to FIG. 2B. In this way, some embodiments generate a multi-modal transformer network for multiple choice question answering using ViT for visual feature extraction and BERT for question processing and answer classification.

FIG. 5B depicts one embodiment of the language encoder 530 in more detail. This language encoder 530 embodiment in FIG. 5B uses a BERT model to attend visual features using cross-attention. This language encoder 530 embodiment comprises a first multi-head self-attenuation model 570 that may receive as input question and answer pairs, a multi-head cross-attenuation model 580 that compares the output from the VIT encoder engine 520 as a second key value pair, and a feedforward block. These are basic transformer blocks in this embodiment, designed to implement cross-attention between text tokens and visual tokens coming from respective encoders. In this way, FIG. 5B depicts a network module merging the representations of the two modalities (image and text) in order to use both sources of data to solve the task.

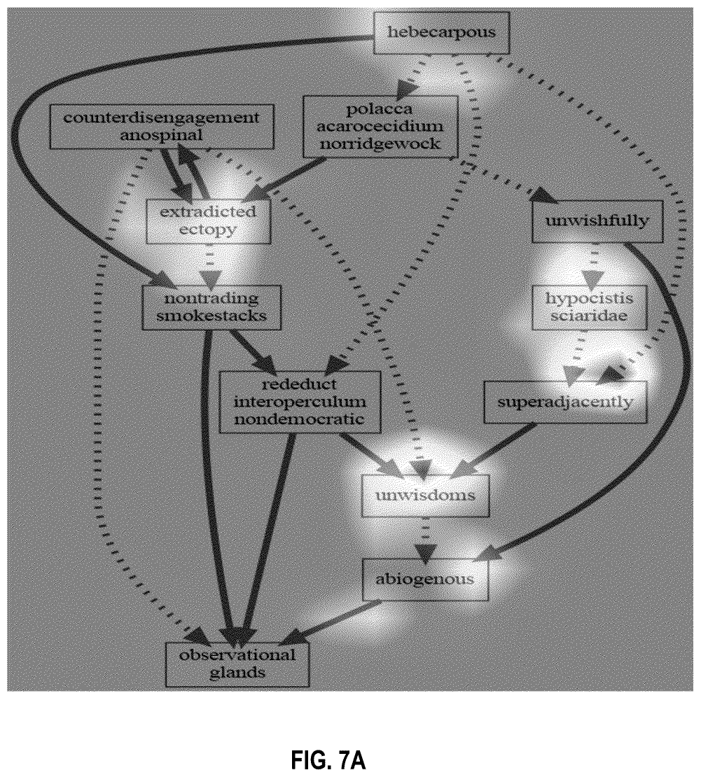

FIG. 6 is a flowchart depicting one method 600 of implementing a Question Answering (QA) system for graph-like charts, consistent with some embodiments. Method 600 may comprise generating a synthetic dataset 350 of graph-like chart images at operations 610-630. Generating the synthetic dataset 350 may include rendering a plurality of graph-like charts 320 from a plurality of associated dataset parameters 305 at operation 610. The graph-like charts 320 may comprise a flowchart in some embodiments, and the rendering may comprise rendering a plurality of images of flowcharts, and generating one or more bounding box annotations for each of the random flowcharts. The dataset parameters 305, in turn, may comprise nodes, edges, labels, and style settings for the flowchart.

Generating the synthetic dataset 350 may further include generating a plurality of question-answer pairs for each of the plurality of graph-like charts at operation 620. The plurality of sets of question-answer pairs for each of the plurality of flowcharts may include topological questions about an underlying graph of the associated flowchart. The plurality of question-answer pairs for each of the plurality of flowcharts may include geometric questions about spatial relations in the associated flowchart. The plurality of question-answer pairs for each of the plurality of flowcharts may include semantic questions about a content of an element in the associated flowchart. Each set of questions-answer pairs may comprise a set of possible answers and one correct answer, and the set as-a-whole may be balanced/optimized by removing trivial question-answer pairs.

In some embodiments, generating the plurality of question-answer pairs for each of the plurality of flowcharts may comprise generating one or more topological questions pertaining to a graph structure of the flowchart by value assignment in a predefined structure template; and producing one or more geometrical questions pertaining to a graphical rendering of the flowchart by value assignment in a predefined graphical template.

Generating the synthetic dataset 350 may further include calculating, at operation 630, a plurality of annotations for each of the plurality of question-answer pairs from the plurality of associated graph data. In some embodiments, this may also generate edge annotations using the VLNN 325.

In some embodiments, generating the synthetic dataset 350 of flowchart images may further comprise (not shown) receiving a real world flowchart dataset 355, wherein the real world flowchart dataset comprises textual labels having a semantic distribution; computing statistics of the real-world flowchart dataset, including a distribution of nodes and edges characteristics and a distribution of graphical styles; generating, using a pretrained language model, a plurality of labels matching the semantic distribution of provided labels; generating graph data matching the computed distribution of nodes and edge characteristics and the computed distribution of graphical styles; rendering the plurality of flowchart images and the question-answer pairs using the graph data; and filtering of the flowchart images based on a similarity to the real-world flowchart dataset, and augmenting the real world flowchart dataset with synthetic data without changing the question-answer pairs from the real world flowchart dataset. The augmenting may minimize change to a region of the flowcharts attended by the current vision-language architecture; and the augmenting may maximize a difference between the flowcharts in the real world flowchart in terms of content and connectivity. Training the vision-language architecture on the synthetic data to answer questions about the flowcharts, in turn, may comprise iteratively adapting the vision-language architecture using the synthetic data and adapting the synthetic data using the current vision-language architecture and the real world flowchart data.

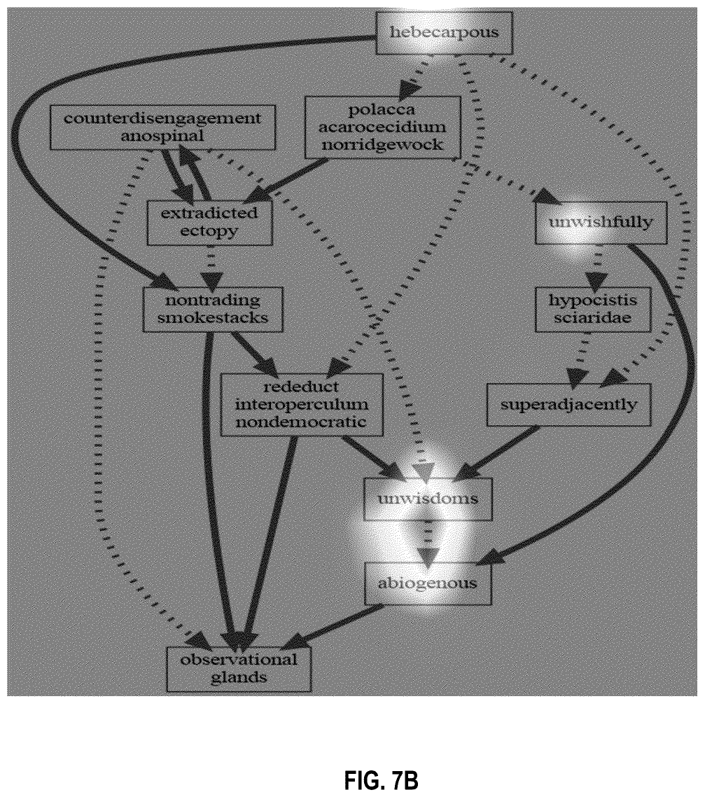

Method 600 may further comprise training, at operation 650, a vision-language neural network (VLNN) 325 on the synthetic data to answer questions about the graph-like chart images at operation 630. The VLNN 325 may comprise a Bidirectional Encoder Representations from Transformers (BERT) model and a Vision Transformer (ViT). In these embodiments, the VIT may be used to identify edge annotations using heat maps. FIGS. 7A and 7B are examples of heat maps used to visualize the cross-attention module activation with respect to an example flowchart, projected by the question text on the image, averaged all across transformer layers and heads.

Method 600 may further comprise receiving, from an end user via a user interface, a question about the flowchart for the trained vision-language architecture at operation 660. In response, the trained vision-language architecture may generate at operation 670 an answer to the question, and then present at operation 680 the generated answer to the end user via the user interface.

### Example Results

In operation, one embodiment of this disclosure generated a benchmark dataset of 5,964,647 questions and 992,057 images for training, 610,309 questions and 99,284 images for validation and 585,179 questions and 99,139 images. The created benchmark dataset contained directed and undirected graphs with 8 to 16 nodes and 12 to 24 edges. Nodes styles in the benchmark set were either solid rectangles or two or three randomly selected different node styles. Node labels contained one to three words sampled randomly from the vocabulary. Edges were either solid lines or randomly drawn from two different node styles. Edge labels could be empty, numeric, or textual, in which case the edge labels in the created benchmark dataset were represented by a single word drawn from the vocabulary. The number of generated images was evenly distributed across all parameters, and the vocabularies of the train, val and test splits are disjunct. That is, data was partitioned into three parts, one used for training, another for validation (pseudo-test intended to tune the parameters), and the third one for actual test of the complete trained system. Next, up to four negative answers were generated for each question. An example of an image with QA annotations can be seen in FIG. 4A.

Results of this example on an unseen test split of the disclosed synthetic dataset and zero shot performance on the real data using a model that was only fine-tuned on the synthetic data are shown in Table 1.

TABLE 1

| | QA Accuracy (%) | | |
|---|---|---|---|
| Dataset | Random | Text-Only model | VL Model |
| Synthetic | 32.82 | 34.96 | 72.89 |
| Real* (zero shot) | 20.00 | 21.05 | 26.32 |

Text-Only was a variant of the VL model in this example, which did not have access to the visual features.

This example used a multi-modal transformer model as baseline, which in turn, used the flowchart image, question and answer candidates (cf. FIG. 2A) for multiple-choice question answering. Each image in this example was rescaled to 224×224 pixels and a visual embedding was extracted from a grid of 14×14 patches using a Vision Transformer model, such as that described in Alexey Dosovitskiy et al. An Image Is Worth 16×16 Words: Transformers for Image Recognition at Scale. Jun. 3, 2021. arXiv: 2010.11929. Each answer candidate in this example was concatenated with the question and processed by a transformer, such as the BERT described in Jacob Devlin et al. “BERT: Pre-Training of Deep Bidirectional Transformers for Language Understanding,” Proceedings of the 2019 Conference of the North American Chapter of the Association for Computational Linguistics: Human Language Technologies, Volume I (Long and Short Papers). NAACL-HLT 2019. Minneapolis, Minnesota: Association for Computational Linguistics, June 2019, pp. 4171-4186. doi: 10.18653/v1/N19-1423. This transformer was beneficial because it could attend to the image features with cross-attention to predict a probability distribution over the answer candidates.

This example used the “huggingface” transformers library described in Thomas Wolf et al. “Transformers: State-of-the-Art Natural Language Processing,” in: Proceedings of the 2020 Conference on Empirical Methods in Natural Language Processing: System Demonstrations. Online: Association for Computational Linguistics, October 2020, pp. 38-45. doi: 10.18653/v1/2020.emnlp-demos.6, for its implementation of a transformer models. Pre-trained weights were used for BERT and ViT. The example was used to train all of the baseline systems on the training split for up to three epochs and check performance on a random sample of ten percent of the validation split five times per epoch. Training stopped early if no improvement was observed over three validation runs. Each model was trained with cross entropy loss and Adam optimizer with a learning rate of 10⁻⁵ and a batch size of 256 on a single NVIDIA RTX A6000 GPU.

### GENERAL

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method of implementing a Question Answering (QA) system, comprising:
generating a synthetic dataset of graph-like chart images, the generating comprising:
rendering a plurality of graph-like chart images from a plurality of associated graph data;
generating a plurality of question-answer pairs for each of the graph-like chart images; and
calculating a plurality of ground truth annotations for each of the plurality of question-answer pairs and associated graph-like chart images from the plurality of associated graph data; and
training a vision-language architecture on the synthetic dataset to answer questions about the graph-like chart images.

2. The method of claim 1, wherein the graph-like charts are flowcharts.

3. The method of claim 2, wherein question-answer pairs for each of the graph-like charts include topological questions about an associated underlying graph.

4. The method of claim 2, wherein the plurality of question-answer pairs for each of the plurality of graph-like charts include geometric questions about spatial relations in the associated graph-like chart.

5. The method of claim 2, wherein the plurality of question-answer pairs for each of the plurality of graph-like charts include semantic questions about a content of an element in the associated graph-like chart.

6. The method of claim 2, wherein the vision-language architecture comprises a Bidirectional Encoder Representations from Transformers (BERT) model and a Vision Transformer (ViT).

7. The method of claim 6, wherein the training of the vision-language architecture on the synthetic dataset to answer questions about the graph-like chart images comprises generating a representation of the graph-like chart images using the VIT.

8. The method of claim 7, further comprising generating edge annotations using heat maps.

9. The method of claim 2, wherein the rendering of the plurality of graph-like charts from a plurality of associated input files comprises:
rendering a plurality of images of random graph-like charts; and
generating one or more bounding box annotations for each of the random graph-like charts.

10. The method of claim 2, further comprising:
receiving, from an end user via a user interface, a question about the graph-like charts;
generating, by the trained vision-language architecture, an answer to the question; and
presenting the generated answer to the end user via the user interface.

11. The method of claim 2, wherein the graph data comprises nodes, edges, labels, and style settings for the graph-like chart.

12. The method of claim 2, wherein each set of questions and answers comprises a set of possible answers and one correct answer.

13. The method of claim 12, wherein generating a synthetic dataset of graph-like chart images further comprises balancing the set of questions to remove trivial question and answer pairs.

14. The method of claim 2, wherein generating the plurality of question-answer pairs for each of the plurality of graph-like charts comprises:
generating one or more topological questions pertaining to a graph structure of the graph-like chart by value assignment in a predefined structure template;
producing one or more geometrical questions pertaining to a graphical rendering of the graph-like chart by value assignment in a predefined graphical template; and
producing answers for the one or more questions using ground truth data for the graph-like chart by analyzing underlying graph and spatial locations using a graphing algorithm.

15. The method of claim 2, wherein the generating of the synthetic dataset of graph-like chart images comprises:
receiving a real world graph-like chart dataset, wherein the real world graph-like chart dataset comprises textual labels having a semantic distribution;
computing statistics of the real-world graph-like chart dataset, including a distribution of nodes and edges characteristics and a distribution of graphical styles;
generating, using a pretrained language model, a plurality of labels matching the semantic distribution of provided labels;
generating graph data matching the computed distribution of nodes and edge characteristics and the computed distribution of graphical styles;
rendering the plurality of graph-like chart images and the question-answer pairs using the graph data; and
filtering of the graph-like chart images based on a similarity to the real-world graph-like chart dataset.

16. The method of claim 15, wherein the training of the vision-language architecture on the synthetic dataset to answer questions about the graph-like charts comprises:
iteratively adapting the vision-language architecture using the synthetic dataset and adapting the synthetic dataset using the current vision-language architecture and the real world graph-like chart data.

17. The method of claim 15, further comprising augmenting the real world graph-like chart dataset with synthetic data.

18. A computer program product for implementing a Question Answering (QA) system, the computer program product comprising a computer readable storage medium having program instructions embodied therewith, the program instructions executable by a processor to cause the processor to:
generate a synthetic dataset of flowcharts images, the generating comprising:
rendering a plurality of flowcharts images from a plurality of associated graph data;
generating a plurality of question-answer pairs for each of the flowchart chart images, wherein question-answer pairs for each of the graph-like charts include topological questions about an associated flowchart, geometric questions about spatial relations in the associated flowchart, and semantic questions about a content of an element in the associated flowchart; and
calculating a plurality of ground truth annotations for each of the plurality of question-answer pairs and associated flowcharts images from the plurality of associated graph data; and
train a vision-language architecture on the synthetic dataset to answer questions about the graph-like chart images, wherein the vision-language architecture comprises a Bidirectional Encoder Representations from Transformers (BERT) model and a Vision Transformer (ViT), and wherein the training of the vision-language architecture on the synthetic dataset to answer questions about the graph-like chart images comprises generating a representation of the graph-like chart images using the ViT.

19. A system for providing answers to questions posed about flowcharts, wherein the flowcharts are provided as images, comprising:
a synthetic dataset generation module adapted to generate a plurality of synthetic flowchart images and a plurality of questions, possible answers, and correct answer tuples from associated graph data; and
a vision-language machine learning model trained on the synthetic dataset to answer questions about input flowcharts.

20. The system of claim 19, further comprising an adaptation module adapted to receive an annotated real-world dataset of flowchart images and to adjust vision-language machine learning model to answer questions about similar flowcharts.
